(19) United States
(12) Patent Application Publication
(10) Pub. No.: US 2019/0235369 A1
(43) Pub. Date: Aug. 1, 2019

(54) PROJECTION SYSTEM AND METHOD FOR IMPROVED COLOR PERFORMANCE

(71) Applicants: BARCO N.V., Kortrijk (BE); BARCO FREDRIKSTAD AS, Gamle Fredrikstad (DE)

(72) Inventors: Peter JANSSENS, Nazareth (BE); Oyvind SVENSEN, Ski (NO); Tobby SIMONSEN, Gamle Fredrikstad (NO)

(73) Assignees: BARCO N.V., Kortrijk (BE); BARCO FREDRIKSTAD AS, Gamle Fredrikstad (NO)

(21) Appl. No.: 16/317,953

(22) PCT Filed: Jul. 6, 2017
(86) PCT No.: PCT/EP2017/066992

§ 371 Date: Jan. 15, 2019

(30) Foreign Application Priority Data
Jul. 15, 2016 (GB) 1612341.6

(51) Int. Cl. G03B 21/20; G02B 26/00; G03B 33/08; G02B 27/14; G03B 21/00

(52) U.S. Cl. CPC G03B 21/204; G02B 26/008; G03B 33/08; G03B 21/005; G02B 27/141; G03B 21/208; G03B 21/2066; G03B 21/2013

(57) ABSTRACT

A system for solid state illumination where light from at least two assisting light sources are added to a phosphor converted light beam. To provide efficient and economical operation, different amounts of the assisting light can be added at different points in time. The overall brightness and/or the color performance of the system can be enhanced.

The present invention relates to systems and methods for projection illumination comprising illumination by solid state light sources and means for wavelength conversion as well as a controller for controlling such systems and software for implementing the methods.

### BACKGROUND OF THE INVENTION

In the field of projection illumination it is possible to use a solid state light beam of a certain color, e.g. blue, and convert the light beam into another color using a segment of a color conversion material, e.g. based on phosphor. For example, to create green and red light, one can use blue light together with a narrow-band (e.g. 20 nm FWHM) green phosphor and a narrow-band red phosphor. However, the availability of efficient red phosphor materials is very limited since these materials suffer from thermal saturation. Therefore it is common to use a yellow phosphor with a broad spectrum and filter the light beam to a wished color, e.g. by means of a color wheel. In this way one can create a blue, red and a green primary, sequentially in time. A drawback of this approach can be that the yellow phosphor spectrum may contain only a small amount of light that can be used for the generation of the red color. FIG. 1 shows an example of a graph of the intensity 1 as a function of the wavelength (nm) 2, comprising the blue excitation light 3, the green light 4 and red light 5 of the excited phosphor light. If the red primary is not bright enough one can compensate by using a larger segment are on the colour wheel for red resulting in a longer segment time in the sequential filtering. But this would decrease the available segment area to use for the remaining primary colors, and the overall output brightness of the projector will be decreased. Alternatively, the red primary brightness can be boosted by also including e.g. the yellow-orange part of the spectrum. However this will lead to a poor color point of the red. For a projection system only based on color conversion, there will always be a trade-off between brightness and color point.

### SUMMARY OF THE INVENTION

In one embodiment of the present invention there is provided a system for solid state illumination, at least three solid state light sources, means for color conversion, for example a color converter, means for combining light beams, for example a light combiner, and means for color filtering, for example a color filter, where a first light source provides a first light beam that can be converted by the means for color conversion into at least one converted light beam, and a second and a third light source provides a second and third light beam respectively. The at least one converted light beam can be combined with the second-and/or third light beam, by the means for combining light beams, into a composed light beam that can be filtered by the means for color filtering, and wherein the second and third light beams comprises different primary colors, and the spectra of the converted light beam comprises at least one of said primary colors.

The system provides the advantage of being able to increase color saturation and overall brightness of the primary light beams.

In another embodiment, the system comprises the second- and third light beams being combined into one light beam before being blended with the converted light beam.

This enables a more compact system design where components can be shared.

In another embodiment, the system comprises that the optical output of the first light source is constant in time while the optical output of any of the second- and third light source is modulated in time. The modulation range can be between 100% and 0% or between 100% and 10% above the lasing threshold of the light source.

This brings the advantage of adding an appropriate amount of assisting light only when needed, which can save power consumption and lifetime of the light source. In case a small amount of assisting light is needed, the optical output is kept above the light source's lasing threshold to maintain a stable operation.

In another embodiment, the system comprises setting the output level of any of the second- and third light source to provide a pre-defined white point comprising the combination of all light beams.

This brings the advantage of being able to adapt the white point without having to alter the phosphor light (which often reduces the brightness).

In another embodiment the system comprises the addition of light from at least one assisting light source to the converted light beam. The assisting light source can be red or blue.

The assisting laser light can boost the brightness and/or improve the color point of the primaries.

In another embodiment, the system comprises means for color conversion, for example a color converter, being at least one phosphor surface, with one type of phosphor, for example yellow phosphor, or segments of a multiple of phosphors in different colors.

In another embodiment, the system comprises rotating the means for color conversion or keeping it in a non-moving state. With an additional blue laser in the system, it is possible to have the means for color conversion, for example a color converter, in a static state. Hence, the means for color conversion can be static or moveable.

In another embodiment, the system comprises the means for combining light beams, for example a light beam combiner, comprises a color selective mirror, for example a dichroic mirror or a prism with a dichroic surface.

This makes it possible to filter out light beams with different properties from a combined light beam.

In another embodiment, the system comprises at least one light source having at least one sub-set of a multiple of light sources.

In another embodiment, the system comprises that the combination of the second- and third light beam is unpolarised.

This will reduce speckle effects, allowing a larger amount of assisting light in the final light beam.

In another embodiment, there is provided a method for solid state illumination comprising at least three solid state light sources, the method comprising the steps of the first light source generating a first light beam, and converting the first light beam into at least one converted light beam, a second and third light source generating a second and third light beam with different primary colors, and combining the at least one converted light beam with the second and/or third light beam into a composed light beam by the means for combining light beams, the converted light beam comprising at least one of the above mentioned primary colors, filtering the composed light beam by the means for color filtering.

The method provides the advantage of being able to increase color saturation and overall brightness of the primary light beams.

In another embodiment, the method comprises first combining the second and third light beam into one light beam and then blending the combined light beam with the converted light beam.

This enables a more compact system design where components can be shared.

In another embodiment, the method comprises keeping the optical output level of the first light source constant over time, and modulating the optical output level of any of the second- and third light source in time. The output level can be modulated between 100% and 0% or between 100% and 10% above the lasing threshold of the light source.

This brings the advantage of being able to add an appropriate amount of assisting light only when needed, which can save power consumption and lifetime of the light source. In case of adding a small amount of assisting light, the optical output is kept above the light source's lasing threshold to maintain a stable operation.

In another embodiment, the method comprises adapting the optical output levels of any of the second- and third light source and generating, with all light beams, a predefined white point. This brings the possibility of adapting the white point without having to alter the phosphor light (which often reduces the brightness).

In another embodiment the method comprises adding light from any of the second- or third light source to the converted light beam. The assisting laser light can boost the brightness and/or improve the color point of the primaries.

In another embodiment, the method comprises rotating the means for color conversion or keeping it in a non-moving state.

With an additional blue laser in the system, it is possible to have the means for color conversion, for example a color converter, in a static state. The means for color conversion can be static or moveable.

In another embodiment, the method comprises filtering any combination of converted-, second-, third- or converted assisting light beam using dichroic surfaces.

This makes it possible to filter out light beams with different properties from a combined light beam.

In another embodiment, the method comprises arranging the polarization directions of the individual light sources of the second- and third light source so that the second- and third beam, or the combination of the two, is unpolarised.

This will reduce speckle effects, allowing a larger amount of assisting light in the final light beam.

In another embodiment, there is provided a controller for controlling solid state illumination comprising at least three solid state light sources, the first light source generating a first light beam, a converter for converting the first light beam into at least one converted light beam, a second and third light source generating a second and third light beam with different primary colors, and a combiner for combining the at least one converted light beam, with the second and/or third light beam into a composed light beam, the converted light beam comprising at least one of the above mentioned primary colors, a filter for filtering the composed light beam, the controller being adapted to keep the optical output level of the first light source constant over time, and to modulate the optical output level of any of the second- and third light source in time.

The controller provides the advantage of being able to increase color saturation and overall brightness of the primary colors in a system for solid state illumination, e.g. by modulating the optical output level of assisting laser sources.

In another embodiment, the controller is adapted to keep the optical output level of the first light source constant over time, and modulating the optical output level of any of the second- and third light source between 100% and 0% or between 100% and 10% above the lasing threshold of the light source.

This brings the advantage of being able to add an appropriate amount of light only when needed, which can save power consumption and lifetime of the light source. In case of adding a small amount of assisting light, the optical output is kept above the light source's lasing threshold to maintain a stable operation.

In another embodiment, the controller is adapted to controlling the optical output levels of any of the second- and third light source and generating, with all light beams, a predefined white point.

This brings the possibility of adapting the white point without having to alter the phosphor light (which often reduces the brightness).

In another embodiment, the controller is adapted to rotate a color converter or to keep it in a non-moving state.

With an additional blue laser in the system, it is possible to have the means for color conversion, for example a color converter, in a static state. The means for color conversion can be static or moveable.

A computer program product is provide that when executed on a processing engine, provides the following function:

controlling solid state illumination provided, for example by at least three solid state light sources, the first light source for example generating a first light beam, and/or

converting the first light beam into at least one converted light beam, and/or

generating from a second and third light source a second and third light beam with different primary colors, and/or

combining the at least one converted light beam, with the second and/or third light beam into a composed light beam, the converted light beam comprising at least one of the above mentioned primary colors, and/or

filtering the composed light beam,

keeping the optical output level of the first light source constant over time, and/or

modulating the optical output level of any of the second- and third light source in time.

Further embodiments of the computer program product are defined in the dependent claims.

The computer program can be stored on a non-transitory storage medium such as an optical disk, a magnetic hard-disk, a magnetic tape, a solid state memory, or similar.

### BRIEF DESCRIPTION OF THE DRAWINGS

FIG. 1 shows an embodiment of the present invention comprising the spectra of conventional phosphor converted light.

FIG. 2 shows an embodiment of the present invention comprising a projection system with a multiple laser sources.

FIG. 3 shows an embodiment of the present invention comprising an arrangement of laser sources.

FIG. 4 shows an embodiment of the present invention comprising a multiple of arrangements of laser sources providing different polarizations.

FIG. 5 shows an embodiment of the present invention comprising the reflection edge of a dichroic mirror.

FIG. 6 shows an embodiment of the present invention comprising the use of assisting laser sources.

FIG. 7 shows an embodiment of the present invention comprising different color points.

FIG. 8 shows an embodiment of the present invention comprising a spectra after passing a color selective mirror.

FIG. 9 shows an embodiment of the present invention comprising the transmission spectra of a color wheel.

FIGS. 10a to d show embodiments of the present invention comprising the drive schemes of the different light sources.

FIGS. 11a to d show embodiments of the present invention comprising the drive schemes of the different light sources.

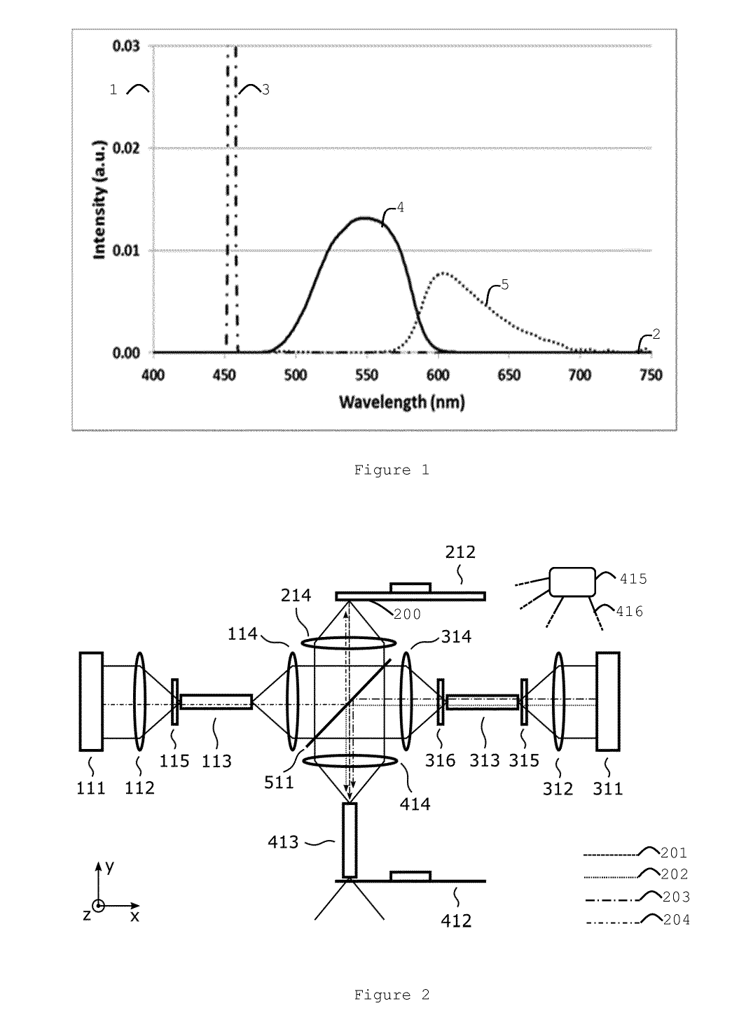

### DEFINITIONS

As the present invention is related to improvements in the generation of colors for projection systems, several terms used throughout the current description are provided hereby.

Any or all of the filters can be reflecting or transmitting filters. For example, the various transmissions of the colors of the waveband reduction filter can be provided by reflections of a reflective waveband reduction filter or transmissions of a transmissive filter or a combination of these.

In a projection system, the definition of a “primary color” is complex as it depends where the primary color is defined in the optical path, i.e. in each color channel, at the level of the light modulator devices, upstream of the light modulator devices, or at the output of the projector. It is very often that in projection systems the three primary colors are red, green and blue.

In optical terms, a primary color in a projection system is defined as “One color element of three (or more) colors, in an additive imaging system, which can be combined in various proportions to produce any other color.” Each primary color can be further defined, according to a standard, for example DCI standard. It is important to note that a primary color can also be defined in a standard via its color coordinates. A certain waveband and a certain spectral distribution inside this waveband may create a certain color coordinate that is equal to the one defined in a standard. However, different solutions exist with differences in waveband and spectral distributions that can create the same color coordinates.

“White point” is defined, in additive imaging systems, as “the color (or chromaticity coordinates and luminance) that is produced when the system is sent the maximum RGB code values that it can accept”, as defined in Color and Mastering for Digital Cinema by Glenn Kennel, 2006, ISBN-10: 0240808746. Further, the text book specifies that “DCI specifications and SMPTE Standard for Screen Luminance and Chromaticity, the white point is defined as having chromaticity coordinates [0.314 0.351]”. However, this definition of white point is optional, and further the definition used depends on the standard followed. The definition of white point depends on the application. Therefore, the projector white point (or native white point), and the target white point are to be defined. The projector white point (or native white point) is the white point when all three color channels provide their maximum level. The target white point is the standard the projector should reach.

“White point shift” is the drift of the projector white point with time or with dimming of the illumination levels. In a similar manner, the target primary colors are the primary colors defined by a standard, i.e. DCI standard, and the projector primary colors (or native primary colors) are the primary colors provided to each color channel or light modulator device. Native primary colors therefore have no electronic correction. It is clear that the projector primary colors define the projector white point, however, the target primary colors do not necessarily define the target white point.

“Wavelength conversion”: is a process in which a short wavelength excitation light, for example blue or near-UV laser light, can be converted into light with longer wavelength, for example green, yellow or red light. There are materials, such as e.g. phosphor, that can emit longer wavelengths than it is illuminated with. For example it can be illuminated with blue light and emit green or red light. Thus, by utilizing e.g. a red laser diode array and a blue laser diode array, together with at least one conversion material, e.g. phosphor, a light source comprising red, green and blue colours can be obtained. The conversion material could be based on e.g. phosphor materials. Quantum dots can also be used for wavelength conversion.

To facilitate operation, the conversion material, e.g. phosphor, can be put on a wheel that can rotate, this is often referred to as a wavelength conversion wheel.

In the field of projection and the case where a single wavelength conversion material is used, the generated light can be further filtered and split up in primary colors. This can also be implemented by mounting the filter on a rotating wheel and hence often referred to as a filter wheel. If several wavelength conversion materials are used, a filter wheel can still be used to further filter out the whished band widths.

A “light beam combiner” has the ability to receive a multiple of light beams and selectively transmit and/or reflect parts of the received light beams so that the reflected and/or transmitted light beam(s) will have desired properties. Such property can for example be polarization direction and/or wavelength interval. The light beam combiner can be implemented with for example semi-transparent reflecting (e.g. metallic) surfaces or dichroic surfaces.

A “controller” is here referred to as an electronic device which monitors and physically adapts the operation of a system. It may be implemented as an embedded microcontroller or hardware logic arrays or as a separate digital processing unit, e.g. comprising a microprocessor and memory and I/O ports or an FPGA or similar.

### DETAILED DESCRIPTION OF THE INVENTION

It is an objective of the present invention to address the above mentioned issues. In one embodiment of the invention, excitation light from blue solid state light sources such as blue laser sources can be converted by e.g. a wavelength conversion element. In this or other embodiments of the present invention, the wavelength conversion element can be a phosphor, for example a yellow phosphor, whose characteristics depend on the native colors the projection system shall provide. Quantum dots could be used as well as wavelength conversion elements, e.g. especially for lower power projectors. Additionally, assisting red and blue solid state source light such as laser light, from separate sources such as laser sources can be combined with the converted light. The red solid state source light such as laser light can offer the advantage that the color point of the red primary can be boosted towards more saturated red color, while maintaining (and/or increasing) the brightness of the primary. The separate blue from solid state light sources such as lasers can offer the advantage that they can be added to a part of the spectrum from wavelength conversion material such as a phosphor spectrum to improve the color point, for example to obtain a less deeply-saturated blue color point than is obtained with the blue laser only. Without adding the cyan-part of the spectrum from wavelength conversion material such as a phosphor, the blue point may be too low in y (color coordinate of the CIE1931 color diagram), which results in a clipping of the blue primary and cyan colors from the desired color gamut.

When adding more red lasers to the orange-red part of the spectrum from wavelength conversion material such as the phosphor's spectrum to form a red primary, speckle effects can become more pronounced. It may depend on the projector application how much speckle can be tolerated before the image quality is no longer acceptable. For a certain projector platform used in the simulation market the inventors have found that a contribution of up to 30% (or about 30%) laser light (photometrically defined) of the total brightness of the red primary light, may be the upper limit for a preserved image performance. This is valid when a single-wavelength polarized red laser source was used. If all red lasers that will be combined into one red light beam have the same polarization orientation, the combined red laser beam is polarized. If, on the other hand, the individual laser beams have different polarization directions, so that the combined laser beam is unpolarized, the contribution of direct laser light (on the same projector platform as mentioned above) can be increased to 50% (or about 50%) without interfering with image quality, as for example the speckles are reduced. Note that the amount of laser light that can be added also depends on other conditions, for example the spectral width of the red laser source and the optical system that is used to couple the red lasers into the projection optics. Especially how well this optical system suppresses the red laser speckles, and other factors like the projection screen type, etc. can determine the various contributions of the red light sources, i.e. laser versus converted.

U.S. Pat. Nos. 9,000,406 and 8,840,267 disclose a system having one additional blue laser source.

U.S. Pat. No. 9,249,949 discloses a system where the green primary is phosphor converted light and the red and blue primaries origin from separate light sources.

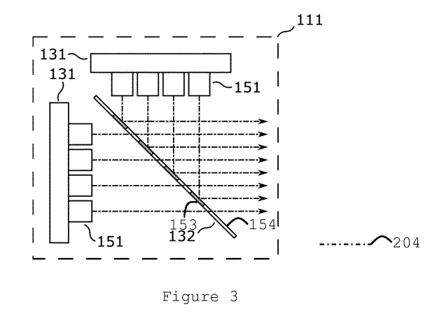

FIG. 2 shows an embodiment of the invention where a blue solid state light source such as a laser source 111 (that may comprise a multiple of laser diodes) can be used to generate excitation light for the means of wavelength conversion. In this embodiment the wavelength conversion is implemented as a wavelength conversion layer such as a phosphor layer 200 which is mounted on a wheel 212 so that the wheel can be rotated while the light beam impinges onto the wavelength conversion layer such as the phosphor. The heat generated in the wavelength conversion layer such as the phosphor can thus be distributed over a larger surface for more efficient heat dissipation. A lens system 214 is preferably placed close to the surface of the wheel 212 so that it can capture the converted light. The converted light 201 (dashed line) can be guided by the lens systems 214 and 414 to the entrance of the main integrating bar 413.

The blue solid state light sources such as pump laser diodes 111 can generate light to illuminate the wavelength conversion layer such as the phosphor 200. The light 204 (short dash and dot line) from these lasers can be collected by a lens system 112 into a beam homogenizer. The beam homogenizer can consist of or comprise a diffusing element 115 (e.g. a diffuser or a diffractive structure, for example a lenslet array) and an integration rod or light tunnel 113. The dimensions of the homogenizer can be matched to the étendue of a spatial light modulator or light valve such as a Digital Micromirror Device (not shown in the figure). The light can impinge onto a color selective reflective device such as a mirror 511 so that it is reflected towards the wavelength conversion layer such as the phosphor 200. The reflective device or mirror can for example be a dichroic mirror (or a prism) having a surface made by thin-film technology. The combination of lens system 114 and 214 creates an image of the exit of beam homogenizer 113 onto the wavelength conversion layer such as the phosphor 200. This homogenization step optimizes the distribution of heat over the surface of the wavelength conversion layer such as the phosphor surface in order to reduce saturation of the light conversion efficiency. For example, if the diffuser 115 is omitted, the efficiency of converting blue light to yellow light, can be reduced, e.g. due to thermal quenching in hot spots in the wavelength conversion layer such as the phosphor.

Red and blue light can be generated in a second solid state light cluster, e.g. laser cluster 311. The solid state light source e.g. the laser source may comprise a multiple of sources for red and/or a multiple of sources for blue. The light from these assisting solid state light sources such as the lasers can be homogenized through a separate lens system 312, a diffusing element 315 and integrating rod 313. The blue light 203 (long dash and dot) and the red light 202 (dots) can thus be homogenized and the resulting light can be imaged onto the entrance of the main beam homogenizer 413 through lens systems 314 and 414 and with help of the color selective reflective device such as the mirror 511. The reflective device such as the mirror 511 also combines the yellow-green light 201 from the wavelength conversion layer such as the phosphor 200 with the assisting red and blue solid state light such as the laser light 203. A second diffuser 316 may be added to the system as this can improve the reduction of speckle in the image. The diffuser 316 can also be brought into motion e.g. for the speckle contrast to be further reduced, e.g. oscillating motion.

The assisting red and blue solid state light sources such as lasers can be mixed into one cluster or they can comprise two separate light sources combined by another dichroic reflective device such as a dichroic mirror. A potential arrangement comprises laser banks mixed into one cluster, where one coldplate can have red laser banks, the other coldplate can have blue laser banks. Note that the blue pump lasers 111 can be located separated from the assisting laser cluster 311, and having a different optical path.

A color filter wheel 412 can be used to clean up the spectrum of the wavelength conversion layer such as the phosphor spectrum and to create the different primary light beams: at least red, green and blue and possibly or optionally any of, some of white, cyan, yellow or other colors. An alternative position (not shown in the figure) for the color wheel 412 can also be between the lens system 414 and beam homogenizer 413. Some locations of the wheel can be more desirable than others regarding the recovery of the so called spoke light. Spoke light can arise e.g. when a light beam is illuminating a segmented color conversion surface while it is moving.

The diffuser 316 can also be placed (not shown here) at the entrance of element 413. This can make the system more compact and lenses 314 and 414 can be more efficiently used. However, the transmission of the wavelength converted light such as the phosphor converted light may be decreased. Another aspect is to match the beam parameters of the wavelength converted light such as the yellow phosphor light to the parameters of the assisting red and blue light (e.g. at the lens 414) to avoid poor color uniformity (see international application WO2015149877 which is incorporated herewith in its entirety). Having the diffuser at location 316 can give more flexibility in tuning the beam parameters of the assisting red and blue lasers to better match the wavelength converted light such as the phosphor converted light, as the latter does not pass diffuser 316. In this case diffuser 315 and 115 can be the same type of component, which can reduce the cost of this component.

The present invention may comprise a controller 415 that can control the operation of any of the components in the system, e.g. the light sources 111 or 311, the means for conversion 212, the color filter wheel 412. The controller can be connected to the different system components via any suitable e.g. arbitrary connections 416. Examples are cable connection, bus connections, wireless connections. This controller 425 is included herewith explicitly in any or all of the embodiments of the present invention as an option.

FIG. 3 shows an embodiment of the present invention where the cluster 111 can comprise two mechanical parts 131 on which the pump lasers 151 can be mounted. The mechanical parts 131 can further comprise means to cool the light sources, such as e.g. heat sinks, fans, or liquid (e.g.) water cooling. This can be obtained by one single glass plate containing zones of reflective 153 or anti-reflective 154 coatings. An alternative solution can be to mount narrow mirrors in a mechanical frame. The cluster 111 may also consist of only one block 131, and it can also contain a more complex optical system, for example as described for cluster 311 in the next section.

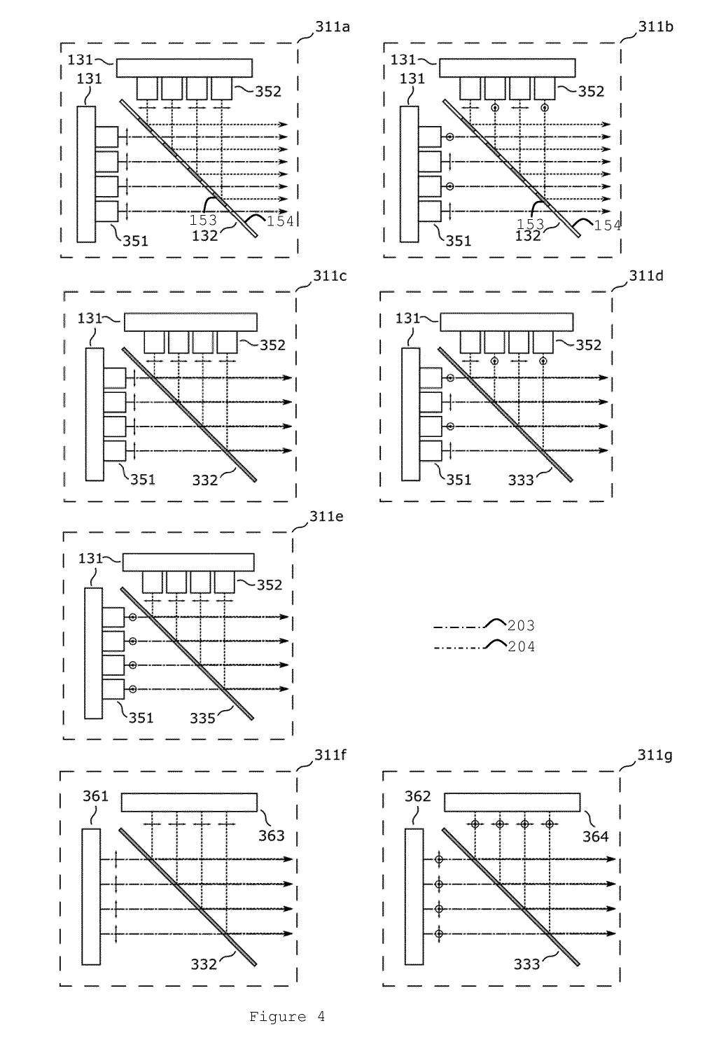

FIG. 4 shows several embodiments of the present invention. FIG. 4 shows a cluster 311a comprising blue light sources 351 and red light sources 352 and a mirror 132 of the same type as used in FIG. 3. Also here, the light sources can be lasers mounted on a cool block 131 so that the light coming from one cool block is polarized. The polarization direction is indicated with arrows. The combined laser cluster 311a can deliver polarized red light 203 and polarized blue light 204. The relative orientation of both polarizations of red and blue light can also be perpendicular.

In cluster 311b the laser sources 351 (blue) and 352 (red) on the cool blocks 131 are mounted in two perpendicular orientations within the same block, as indicated with the arrows perpendicular to- and out of the plane. The mirror 132 can be of the same type as for cluster 311a.

In cluster 311c and 311d, the red 351 and blue 352 light sources are combined using a color selective reflective device such as a colour selective mirror 332. In this example, the reflective device such as the mirror is transparent for blue light and reflective for red light, and both the blue and the red light are polarized. Thus the reflective device such as the mirror 332 can be optimized for these two polarization states.

In cluster 311d the blue and the red light are unpolarised, so the reflective device such as the mirror 333 is optimized for unpolarised light.

Cluster 311e comprises a polarization beam splitter 335 that transmits one polarization and reflects the other. In the example here the red light is polarized in the plane of the paper, and the blue light is polarized in the direction perpendicular to the plane of the paper. The beam splitter 335 transmits the perpendicular orientation, and reflects the parallel polarization orientation.

Clusters 331f and 331g comprise generalized systems where the red 361 and blue 363 sources can be polarized or the red 362 and blue 364 sources can be unpolarised. Components 361 to 364 can themselves each comprise complex sources of lasers, e.g. by combining lasers as for clusters 311a, 311b or 311e. Such an implementation can provide an optimal image quality. For example, polarization diversity can be maximized to suppress laser generated speckles. Another aspect is that the red and blue laser beams can be designed having the same geometrical parameters. Differences in beam profiles (for instance in beam size and/or divergence angles) can result in non-uniform colors on the screen. Thus, matching the light beams can improve e.g. the color uniformity.

The color selective reflective device such as the mirror 511 can be used to combine the yellow-green light from the wavelength conversion layer such as the phosphor 212 with the red and blue light from the laser cluster 311 in the most efficient way. The reflective device such as the mirror can be implemented using e.g. thin-film technology which offers the advantage of a flexible design.

The transition between two reflection levels of the color selective reflective device such as the mirror, can be characterized by the cut off wavelength and the filter steepness.

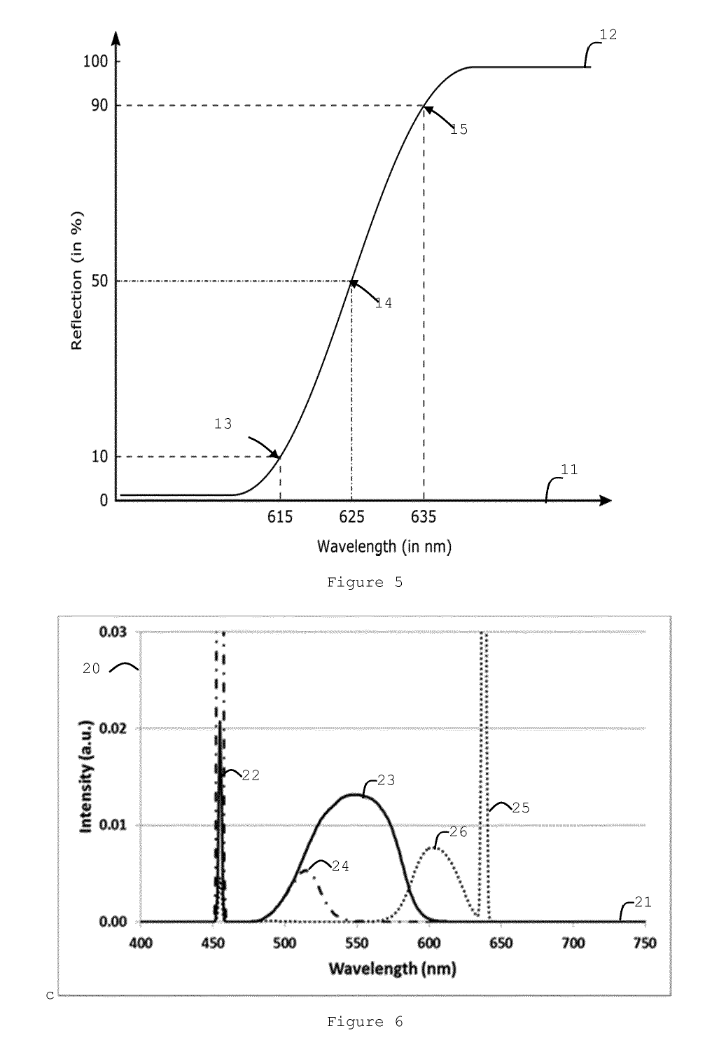

FIG. 5 shows an embodiment of the present invention comprising the reflection 12 at a filter wavelength edge, as a function of the wavelength 11. The cut off wavelength is defined by the wavelength where the reflection is half-way between the two desired reflection (or transmission) values. In this example, the reflection changes from (close to, e.g. less than 10%, less than 1%) 0% to 100% (close to e.g. greater than 90%, greater than 99%). The cut off wavelength is defined by the wavelength where the reflection is 50%, thus around 625 nm. The filter steepness indicates how fast the filter rises from 10% reflection 13 to 90% reflection 15 (or falls from 90% to 10%). In the present embodiment the 10% reflection 13 is located at 615 nm and the 90% reflection 15 is reached at 635 nm. The filter steepness is hence (90%−10%)/(635−615) (%/nm)=4 (%/nm). An alternative definition of steepness can be the wavelength range in which the filter rises from 10% to 90% reflection, being 20 nm in this example.

To obtain an optimized light output, all direct laser light (from the assisting laser sources) should preferably be reflected by the filter and a maximal amount of the converted light should be transmitted through the filter (c.f. the light paths in FIG. 2). In a practical situation, the spectrum of the wavelength conversion layer such as the phosphor's spectrum often overlaps with the lasers' spectrum width somewhat so that 100% transmission of the spectrum of the wavelength conversion layer such as the phosphor spectrum cannot be achieved. It is advantageous if the filter is as steep as possible and the cut off wavelength as close as possible to the laser wavelength.

### Exemplary Embodiments

Due to limitations on the steepness of dichroic reflective devices such as the dichroic mirrors, a design trade-off might be needed when designing a filter. Assuming that a filter that whose filtration rises over for example 20 nm from 10% to 90% reflection is technologically possible (and commercially cost efficient), one could for example design the cut off wavelength at 625 nm, also assuming the minimum wavelength for an assisting laser source is 635 nm. In this example, more than 90% of the laser light can be reflected by the reflective device such the mirror, while also obtaining good transmission of the spectrum of the light from the wavelength conversion layer such as the phosphor spectrum. Moving the cut off to a longer wavelength could increase the transmission of light from the wavelength conversion layer such as the phosphor light, but it could also increase the loss of laser light. Moving the cut off to shorter wavelengths could result in a larger loss of the spectrum of wavelength converted light such as the phosphor spectrum with only a small gain in optical efficiency from the red assisting laser source. Therefore, in one embodiment, a cut off wavelength of 625 nm was selected.

A similar trade off was made in one embodiment for the blue assisting laser source. Using 455 nm blue laser sources can result in a much smaller overlap with the spectrum of the light from the wavelength conversion layer such as the phosphor spectrum, and a cut off wavelength of 485 nm can be selected.

With these design choices the dichroic reflective device such as the dichroic mirror can transmit (substantially) all light in the range [485, 625] nm, while it reflects (substantially) all light in the range of the blue and red assisting lasers, namely [430, 485] nm and [625, 655] nm respectively.

There are two improvements that can be made to the design of the reflective device such as the mirror that enhance the light throughput efficiency of the projection system (at the expense of a more complex and more expensive mirror 511):

In an embodiment according to the present invention which does not comprise laser light with wavelengths longer than 645 nm for example, one can design the reflective device such as the mirror 511 to transmit (substantially) all the light in the range [655, 700] nm. This could improve the overall efficiency of the transmission of the wavelength conversion layer such as the phosphor transmission.

Another embodiment comprises reflective devices such as dichroic mirrors that have been made polarization dependent, so the reflective device such as the mirror 511 could be designed to transmit both polarizations in the range [485, 625] nm. Also it could be designed to transmit the polarization in z-direction (s-polarization) over the ranges [430, 485] nm and [625, 655]. If light from the red and blue laser cluster 311 is polarized in the y-direction (p-polarized) and would be incident e on the reflective device such as the mirror 511, the reflective device such as the mirror would transmit all the light in the range [485, 625] nm (mainly the converted light), but not in the ranges [430, 485] nm and [625, 655], the latter ranges corresponding to the blue and red assisting laser respectively. This design could make the reflective device such as the mirror 511 more complex (and more expensive), but it could result in a higher light output of the projector.

One exemplary embodiment focuses on color performance towards a color gamut (e.g. Rec709, but any gamut can be used in principle). Color filters can be used to boost the brightness (possibly with slightly less saturated colors) or to obtain a wider color gamut (and for example sacrificing brightness). Here follows an embodiment of light composition.

Blue Primary:
Cyan part of the light from the wavelength conversion layer such as the phosphor 212: range [485, 520] nm
Blue lasers from source 311: [450, 460] nm

Green Primary:
Green part of the light from the wavelength conversion layer such as the phosphor 212: [485, 582] nm.
Optionally a small amount of the blue lasers from source 311: [450, 460] nm

Red Primary:
Orange-red part of the light from the wavelength conversion layer such as the phosphor 212: [590, 625] nm
Red lasers from source 311: [635, 645] nm
Optionally a small amount of blue lasers from source 311: [450, 460] nm

The blue pump lasers, which are only used for excitation of the wavelength conversion layer such as the phosphor, will not significantly directly contribute to the light projected onto the screen):
Blue lasers located in source 111: [450, 460] nm.

FIG. 6 illustrates an embodiment of the present invention where the y-axis 20 shows intensity as a function of wavelength on the x-axis 21. In the present embodiment, the red primary is indicated with a dotted line and comprises contributions from the light from the wavelength conversion layer such as the phosphor light peak 26 and the assisting red laser light peak 25. The green primary comprises the full drawn light from the wavelength conversion layer such as the phosphor light peak 23 as well as the blue assisting laser light peak 22. There is also a small contribution of the red light from the wavelength conversion layer such as the phosphor light peak 26 in the green primary. The sharp peak 22 to the left comprises the blue excitation light.

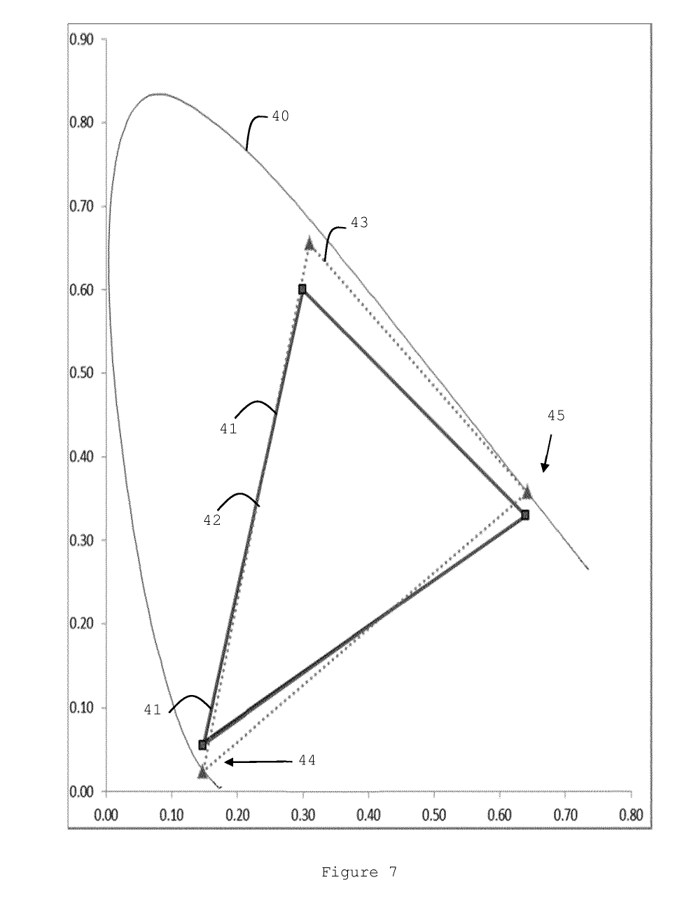

FIG. 7 shows an embodiment of the present invention comprising a target color triangle 41 and the color point 43 of a 455 nm laser. The wavelength conversion layer excitation such as the phosphor excitation is usually done by pump laser diodes of 445 nm or 455 nm. For the blue primary, the non-converted blue light can be used directly. The color point of the above mentioned lasers can be low in the y-coordinate. The target color triangle (Rec709 in this example) is the full line 42. While the color point 43 is larger than the target color gamut 41 it clips a part of the target color gamut around the blue 44 and red 45 primary. Adding assisting red laser light to the red primary light can improve the red primary color point, and adding the cyan part of the light from the wavelength conversion layer such as the phosphor to the blue laser primary can improve the location of the blue color point. The spectra shown in FIG. 6 comprise such corrections, which can provide a very good match between the resulting color gamut 42 and the target Rec709 color gamut 41. In fact the two cannot be distinguished in FIG. 7.

In one embodiment, the wavelength conversion layer such as the phosphor can be a full ring mounted on a spinning disk 212 to keep the temperature under control. In this implementation it is possible to replace the spinning disk by a static wavelength conversion layer plate such as a phosphor plate, if the cooling allows this.

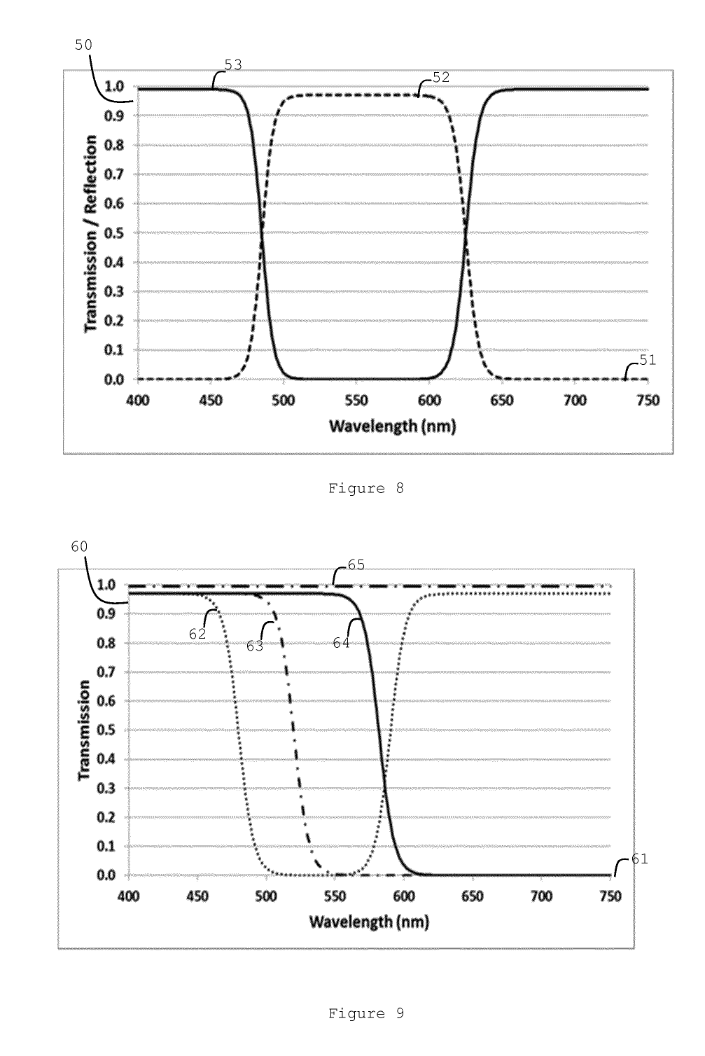

FIG. 8 shows an embodiment of the present invention where the transmission 52 and reflection 53, of an exemplary color selective reflective device such as the mirror 511, are shown as functions of the wavelength.

FIG. 9 shows an embodiment of the present invention comprising the transmission spectra of a color filter. The filter has edges for red 62, blue 63 and green 64, and 65 represents a clear segment where the light from the wavelength conversion layer such as the phosphor light and assisting laser light can pass to provide a white segment.

As described above, a small amount of the assisting blue laser light can be added to the green and red primary. (This is preferred compared to obtaining this with only blue excitation lasers.) This low optical power level of the blue light can be challenging because the laser beam intensity becomes unstable when it is close to the lasing threshold. The lasing threshold is the current at which the laser starts to emit light through the process of stimulated emission. Below the threshold, there is no stimulated emission and only some (low power) spontaneous emitted light could be observed. The instability around the threshold is caused by all kinds of physical processes occurring inside the laser cavity due to e.g. changes in the gain of the laser medium with temperature variations. These instabilities can be visible in the projected images as flicker or color artefacts. Therefore it is better to operate lasers above 10% of the nominal laser power to have enough power to stay away from the instable operating regime. E.g. a laser that can emit 3 W at 2.5 A, and which has a threshold at 0.5 A is better not operated below 0.8 A (which would be about 0.45 W of output light) for stability reasons.

The solution to this issue can be to modulate the blue lasers only between 10% and 100% and to filter the excess of blue in the color wheel: e.g. when 3% of blue laser light contribution is needed, one can e.g. set the lasers to 30% of the nominal power and use a filter wheel that only transmits 10% of the blue light.

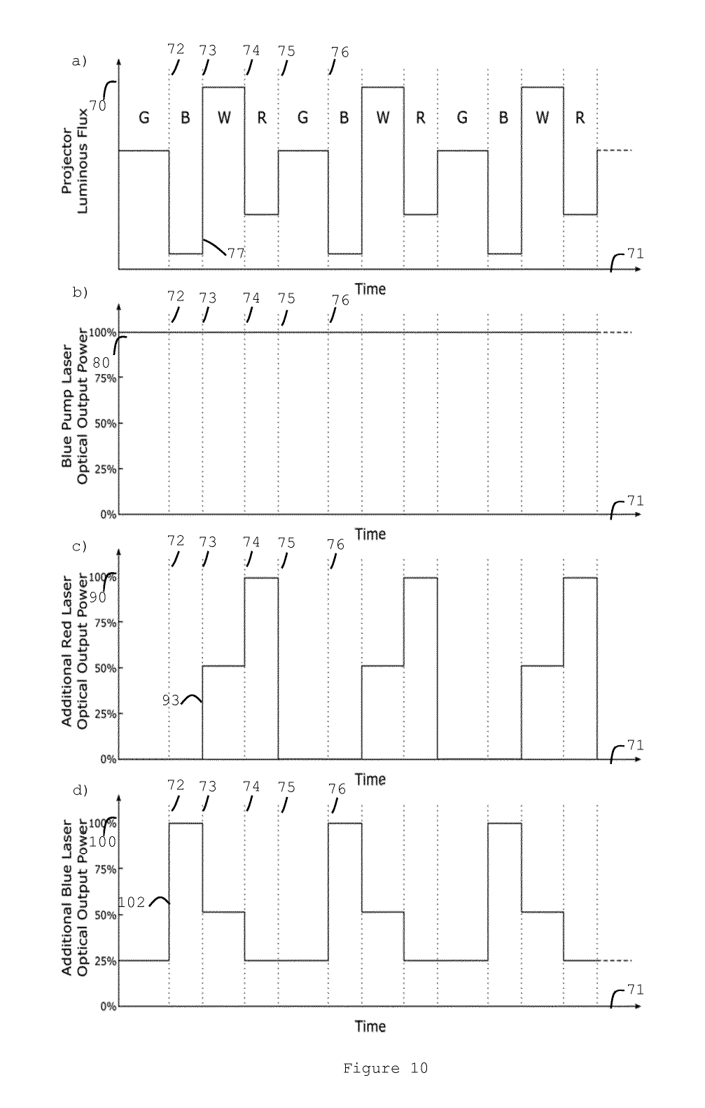

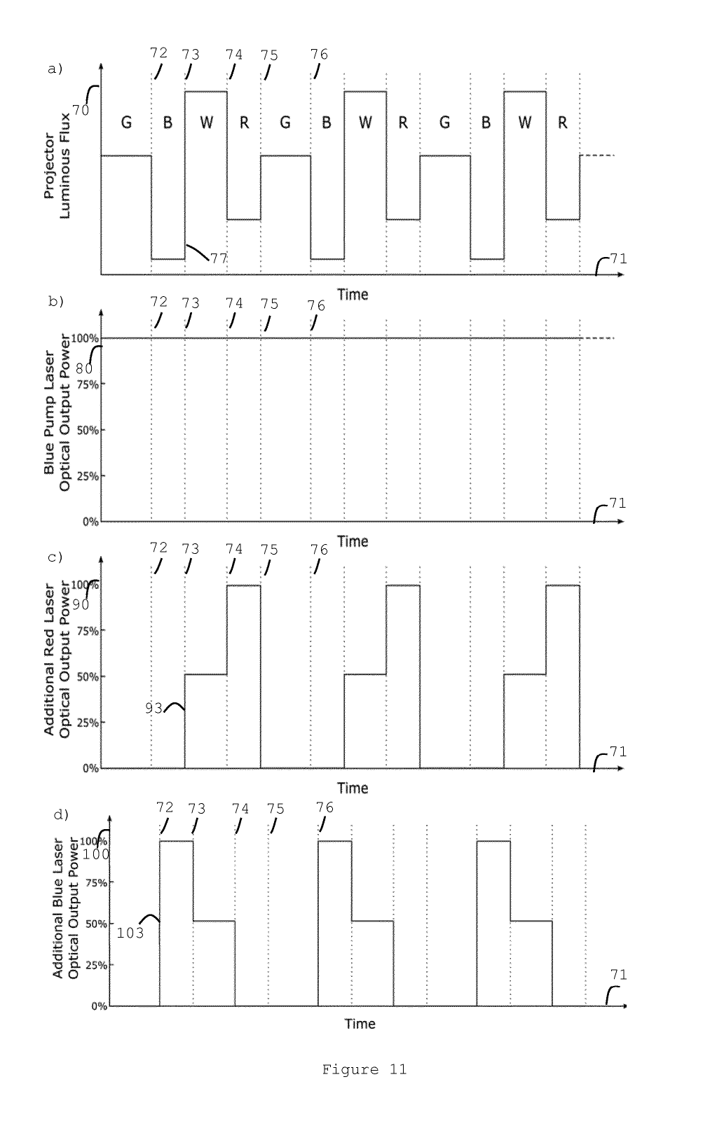

FIGS. 10a) to 10d) and FIGS. 11a) to 11d) illustrates embodiments of the present invention showing the optical output from the projector and the various sources as a function of time 71. The graph in FIG. 10a) has on the y-axis 70 the projector luminous flux (that considers the sensitivity of the human eye) as a function of time 71. The projector luminous flux from the signal from the wavelength conversion layer such as the phosphor signal 77 is segmented in time in different colours, and the dotted lines 72-75 indicate the segment in time for each color: 72-73 is blue, 73-74 is white, 74-75 is red, 75-76 is green. The total segment 72-76 is then repeated throughout the operation. The division into time segments 72-76 are common for all graphs a) to d) in FIGS. and 11. FIG. 10b) has on the y axis 80 the optical output power of the blue pump laser, which is here on a constant level of 100%. FIG. 10c) has on the y-axis 90 the optical output power of the assisting red laser. The output 93 is modulated so that it is at 100% between 74 and 75 to assist in the red segment. During the white segment between 73 and 74, it is at 50% (in general the level can be adapted to better match the white point to a target value). FIG. 10d) has on the y-axis 100 the optical output power of the blue assisting laser. The output 102 is modulated so that it is at 100% between 72 and 73 to assist in the blue segment. During the white segment between 73 and 74, it is at 50%. In general it can be adapted to obtain a correct white point). The present embodiment also comprises adding small amounts of blue assisting laser light to the red 74-75 and green 75-76 segments. The inventors have found that it's advantageous to keep the laser at a level 10% above its lasing threshold to obtain a stable performance. Thus, FIG. 10d) shows how the blue laser output 102 is kept at 25% during the red and green segments.

FIGS. 11a) to 11c) are identical with FIGS. 10a) to 10c). FIG. 11d) shows an embodiment where there is no low level contribution of assisting laser light needed, and the assisting laser can be shut off during the segments 74-75 (red) and 75-76 (green). This operation mode can save power and increase life time of the laser source.

Thus, FIGS. 10a), 10b), 10c) and 10d) can together comprise an embodiment of the present invention where low levels of the assisting blue laser may be added to the spectrum of the red and green light from the wavelength conversion layer such as the red and green phosphor spectrum, for example to improve the color point.

FIGS. 11a), 11b), 11c) and 11d) can together comprise an embodiment of the present invention where the blue assisting lasers are used for the blue part of the spectrum of the light from the wavelength conversion layer such as the phosphor spectrum and for the white segment, and turned off during other color segments.

The optimal values of the driving levels depend on many parameters, e.g. on the sizes of the R, G, B and W segments on the colour wheel. The W segment is the non-filtered signal from the conversion surface. So if the R, G, B segments are adding up to a white point which is close to the target white point of the projector, this means that the W-segment is a true white segment. If the R, G, B segments add up to a white point that is somewhat shifted towards e.g. yellow, this means in that the W-segment can have a slightly blue-shifted color point.

The controller 415 or a control function located in any part of the system can include one or more microprocessors, processors, controllers, or a central processing unit (CPU) and/or a Graphics Processing Unit (GPU), and can be adapted to carry out functions by being programmed with software, i.e. one or more computer programmes.

The controller or control function may have the memory (such as non-transitory computer readable medium, RAM and/or ROM), an operating system running on a microprocessor, optionally a display such as a fixed format display, optionally data entry devices such as a keyboard, a pointer device such as a “mouse”, a touchscreen, or a remote input device such as a smartphone, serial or parallel ports such as I/O ports to communicate with other devices, or network cards and connections to connect to any of the networks or to peripheral devices.

In accordance with another embodiment of the present invention software may be implemented as a computer program product which has been compiled for a processing engine in the controller described above. The computer program product may be stored on a non-transitory signal storage medium such as an optical disk (CD-ROM or DVD-ROM), a digital magnetic tape, a magnetic disk, a solid state memory such as a USB flash memory, a ROM, etc.

In particular software can be embodied in a computer program product adapted to carry out the following functions when the software is loaded onto the respective device or devices (such as the controller) and executed on one or more processing engines such as microprocessors, FPGA, logic circuits etc:

controlling solid state illumination provided, for example by at least three solid state light sources, the first light source for example generating a first light beam, and/or

converting the first light beam into at least one converted light beam, and/or generating from a second and third light source a second and third light beam with different primary colors, and/or

combining the at least one converted light beam, with the second and/or third light beam into a composed light beam, the converted light beam comprising at least one of the above mentioned primary colors, and/or

filtering the composed light beam.

The software can be embodied in a computer program product adapted to carry out the following functions when the software is loaded onto the respective device or devices (such as the controller) and executed on one or more processing engines such as microprocessors, FPGA, logic circuits etc:

keeping the optical output level of the first light source constant over time, and/or

modulating the optical output level of any of the second- and third light source in time.

The software can be embodied in a computer program product adapted to carry out the following functions when the software is loaded onto the respective device or devices (such as the controller) and executed on one or more processing engines such as microprocessors, FPGA, logic circuits etc:

increasing color saturation and overall brightness of the primary colors in a system for solid state illumination.

The software can be embodied in a computer program product adapted to carry out the following functions when the software is loaded onto the respective device or devices (such as the controller) and executed on one or more processing engines such as microprocessors, FPGA, logic circuits etc:

keeping the optical output level of the first light source constant over time, and modulating the optical output level of any of the second- and third light source between 100% and 0% or between 100% and 10% above the lasing threshold of the light source, and/or

controlling power consumption and lifetime of the light source, and/or

keeping the optical output above a light source's lasing threshold to maintain a stable operation, and/or

controlling the optical output levels of any of the second- and third light source and generating, with all light beams, a predefined white point, and/or

adapting a white point without having to alter the phosphor light, and/or

rotating a color converter or to keep it in a non-moving, i.e. static state.

1-45. (canceled)

46. A system for solid state illumination comprising at least three solid state light sources, means for color conversion, means for combining light beams, and means for color filtering, a first light source providing a first light beam that is converted by the means for color conversion into at least one converted light beam, a second and a third assisting light source providing a second and third light beam respectively,
the second assisting light source being a red light source and the third assisting light source being a blue light source,
the at least one converted light beam being combined with the second- and/or third light beam, by the means for combining light beams, into a composed light beam that is filtered by the means for color filtering,
wherein the second and third light beams comprise different primary colors, and the spectra of the converted light beam comprises at least one of said primary colors,
wherein the optical output of the first light source is constant in time while the optical output of any of the second- and third assisting light sources is modulated in time between 100% and 10% above its lasing threshold.

47. The system according to claim 46, wherein the second- and third light beams are combined into one light beam before being blended with the converted light beam.

48-49. (canceled)

50. The system according to claim 46, wherein the output level of any of the second- and third assisting light source is selected to provide a pre-defined white point comprising the combination of all light beams.

51. The system according to claim 46, wherein light from at least one assisting light source is added to the converted light beam.

52. The system according to claim 46, wherein the means for color conversion comprises a phosphor surface, with at least one type of phosphor, for example yellow phosphor.

53. The system according to claim 52, wherein the phosphor comprises segments of different phosphors.

54. The system according to claim 46, wherein the any light source comprises at least one sub-set of a multiple of light sources.

55. The system according to claim 46, wherein the combination of the second- and third light beam is unpolarised.

56. A method for solid state illumination comprising at least three solid state light sources, the method comprising the steps of the first light source generating a first light beam, converting the first light beam into at least one converted light beam, a second and third assisting light source generating a second and third light beam with different primary colors, the second assisting light source being a red light source and the third assisting light source being a blue light source, and combining the at least one converted light beam, with the second and/or third light beam into a composed light beam by the means for combining light beams, the converted light beam comprising at least one of the above mentioned primary colors, filtering the composed light beam by the means for color filtering; and further comprising keeping the optical output level of the first light source constant over time and modulating the optical output level of any of the second- and third light assisting source between 100% and 10% above the lasing threshold of the respective light source.

57. The method according to claim 56 comprising first combining the second and third light beam into one light beam and then blending the combined light beam with the converted light beam.

58-60. (canceled)

61. The method according to claim 56 comprising adapting the optical output levels of any of the second- and third light assisting source and generating, with all light beams, a predefined white point.

62. The method according to claim 56 comprising adding the light from any of the second- or third assisting light source to the converted light beam.

63. The method according to claim 56 comprising arranging the polarization directions of the light sources of the second- and third light assisting source so that the second- and third beam, or the combination of the two, is unpolarised.

64. A controller for controlling solid state illumination comprising at least three solid state light sources, the first light source generating a first light beam, a converter for converting the first light beam into at least one converted light beam, a second and third light assisting source generating a second and third light beam with different primary colors, the second assisting light source being a red light source and the third assisting light source being a blue light source, and a combiner for combining the at least one converted light beam, with the second and/or third light beam into a composed light beam, the converted light beam comprising at least one of the above mentioned primary colors, a filter for filtering the composed light beam,
the controller being adapted to keep the optical output level of the first light source constant over time, and to modulate the optical output level of any of the second- and third assisting light sources between 100% and 10% above the lasing threshold of the respective light source.

65. A computer program product which when executed on a processing engine performs the method steps of claim 56, stored on a non-transitory signal storage device.
